(19) United States
(12) Patent Application Publication
(10) Pub. No.: US 2006/0013644 A1
(43) Pub. Date: Jan. 19, 2006

(54) Loose-leaf binder filler with index card function

(76) Inventor: Eric Yuan, Xindian City (TW)

Correspondence Address: LEONG C LEI, PMB # 1008, 1867 YGNACIO VALLEY ROAD, WALNUT CREEK, CA, 94598, US

(21) Appl. No.: 10/893,252

(22) Filed: Jul. 19, 2004

(51) Int. Cl. B42F 13/00

(52) U.S. Cl. 402/79

(57) ABSTRACT

A loose-leaf binder filler provided with visiting card function comprised of a filler; a rectangular window cut at proper location and sandwich by two see-through sheets each in size slightly larger than that of the filler leaving only top of the window to be inserted with a visiting card; the area of the filler below the window being left blank, lined or checkered to enter into information and/or minutes of meeting related to the visiting card; and one edge of the filler being punched in multiple holes depending on the type of the binder.

### BACKGROUND OF THE INVENTION

The present invention is related to a filler of loose-leaf binder, and more particularly, to one that also functions as an index card.

### DESCRIPTION OF THE PRIOR ART

Visiting cards received are usually put in a dedicated book for future reference. However, while checking out the particular visiting card, we are only access to the name and the company name and it is difficult to refresh the memory of the business talks we had with that particular person. Furthermore, we usually put business talks or summaries of a meeting into a notebook. It happens that we fail to remember the company and its business activities while reviewing out notebook. Therefore, we have to fetch the visiting cards to try putting who and what together, and that is troublesome and inefficient.

### SUMMARY OF THE INVENTION

The primary purpose of the present invention is to provide a filler of a loose-leaf binder that also functions as an index card to help improve time efficiency of conducting business talks.

To achieve the purpose, a rectangular window in a size of a visiting card is cut at where appropriately on the filler; the window is then sandwiched by two see-through sheets each in a size slightly larger than that of the filler; a proper spacing is reserved between both see-through sheets; both sheets are with their edges adhered to the filler leaving only their top edges free for the insertion of a visiting card; the space of the filler below the window is left blank, lined or checkered as applicable to put down information and/or summarized minutes of meeting related to the subject of the visiting card inserted; and a longer side of the filler is punched with multiple holes depending on the type of the binder.

Multiple fillers each provided with a window are put together and bound to the binder to facilitate future reference. Fillers completed by staff from different departments in the same company may be bound together for future reference.

Furthermore, subsequent fillers without windows may be put under the one provided with the window depending on the frequency of the business negotiation with the subject of the visiting card.

Both see-through sheets are bound to the peripheral of the window either by sewing, HF fusion, or adhesion.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is an exploded view of the preferred embodiment of the present invention.

FIG. 3 is a schematic view showing an application of the preferred embodiment of the present invention.

FIG. 4 is a schematic view showing another application of the preferred embodiment of the present invention.

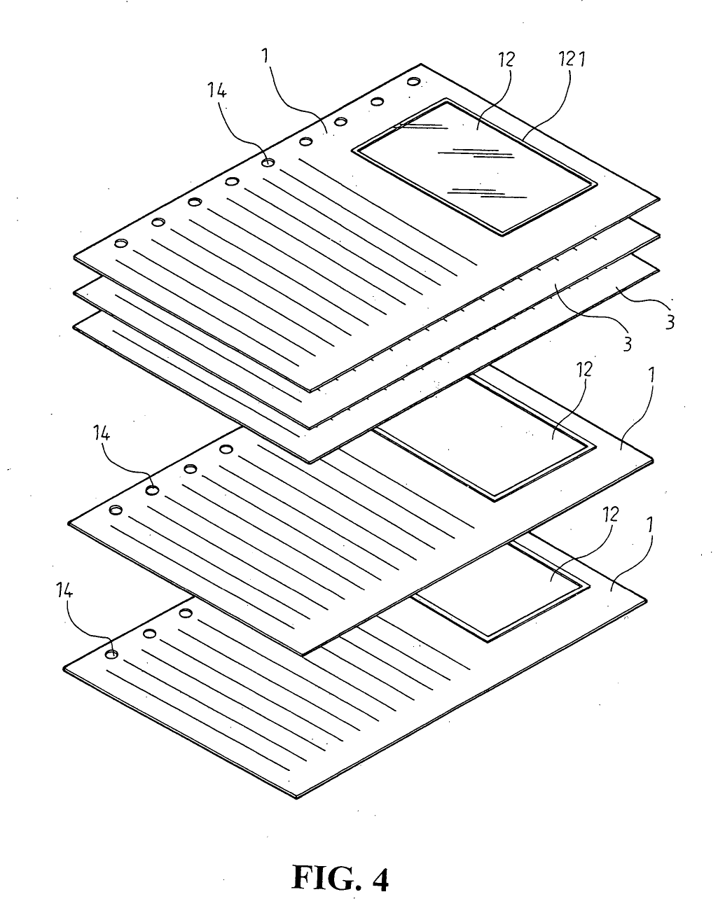

FIG. 6 is a schematic view showing that the preferred embodiment invention is attached to a binder.

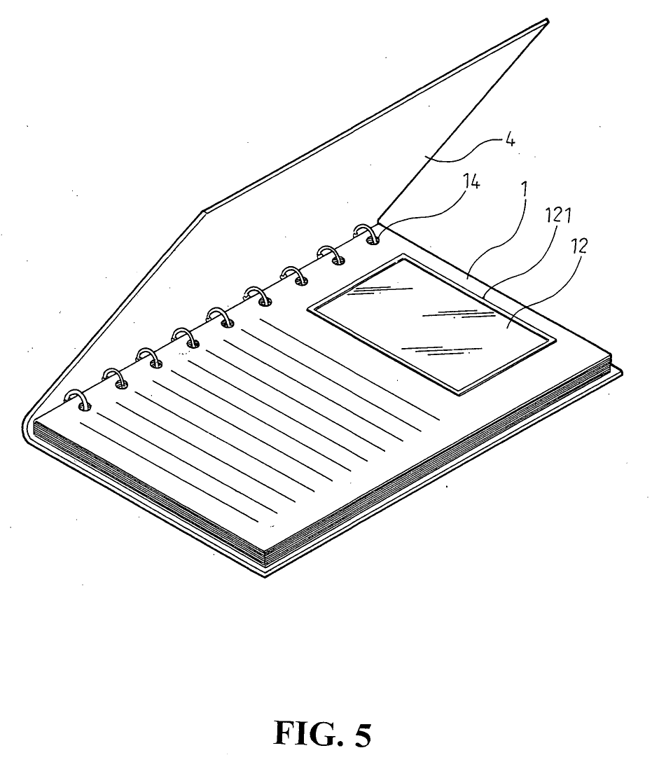

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

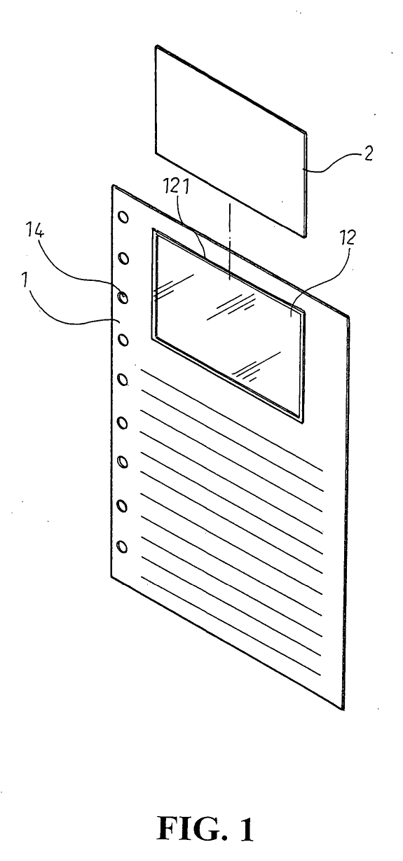

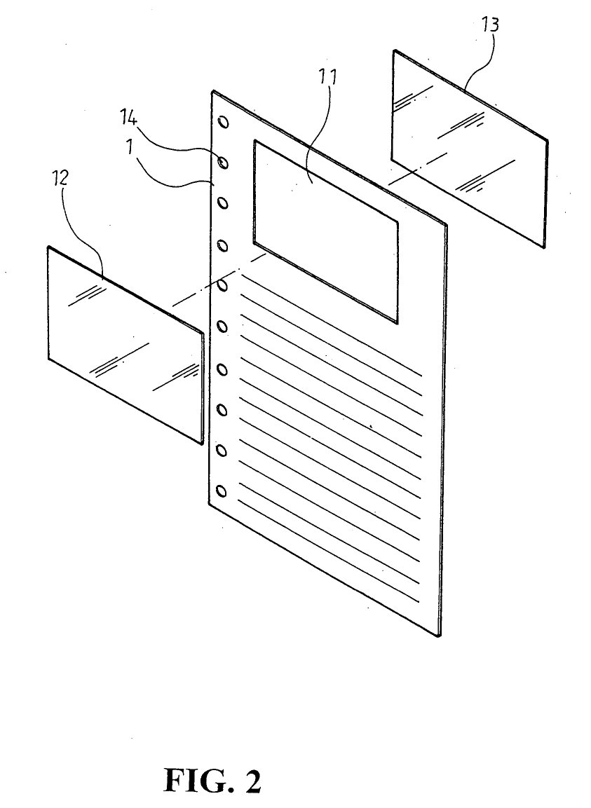

Referring to FIGS. 1 and 2 for a preferred embodiment of the present invention, a filler 1 of a loose-leaf of the binder is provided on its upper portion a rectangular window 11 and the window 11 is sandwiched either by sewing, HF fusion or adhesion by two see-through sheets 12, 13 each in a size slightly larger than that of the window 11. Wherein, both see-through sheets 12, 13 are bound to the peripheral of the window 11 leaving the top edge of the window free and keeping a proper spacing between the peripheral each of both see-through sheets 12, 13 and that of the window 11. The area of the filler 1 below the window 11 is left blank, lined or checkered as applicable and one longer edge of the filler 1 is punched multiple holes 14 for the binder.

A visiting card 12 is inserted into the window from an entrance 121 at the top edge of the window 11. The area below the window 11 is provided for its user to enter into information including summarized minutes of meeting and business talks to become an index card for future reference, and further to become a notebook when multiple fillers are put together to the binder.

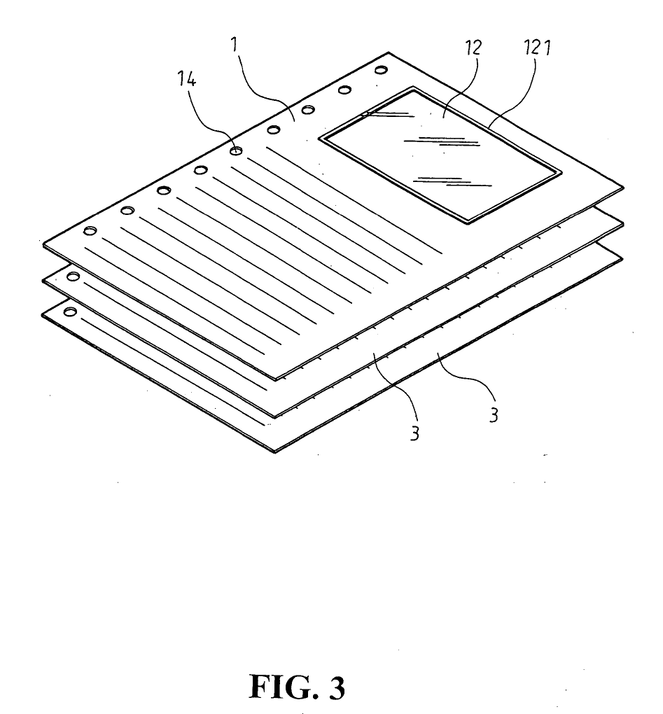

Now referring to FIG. 3, to maintain a consistent history of business talks with the same subject of the visiting card inserted to the filler 1, subsequent fillers each without the window may be added to the first filler 1 to facilitate future reference.

If case of any changed subject of the visiting card, the new visiting card may be inserted into another filler 1 of the present invention and put together with the existing one to prevent any confusion while sourcing the data.

As illustrated in FIG. 5, multiple fillers 1 each punched with multiple holes 14 on one side are collected and bound by a binder 4 to have a fast and easy index without missing any important information.

When compared with the notebooks generally available in the market, the binder containing multiple fillers provided with a window of the present invention provides those advantages including but not limited to:
1. Information related to a particular subject of the visiting card is entered on the same filler inserted with that visiting card to facilitate future reference of the history of the business with the subject.
2. Business information kept by different staff in the same company can be pooled for easy index.
3. Personal events, such as the birthday, anniversary of wedding, may be entered right below the visiting card of that particular person on the same filler to help develop and maintain positive business relation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A loose-leaf binder filler also functioning as an index card having a rectangular window cut at where appropriately on the upper portion of the filler; the window being sandwiched by two see-through sheets each in a size slightly larger than that of the filler; both see-through sheets being attached with their peripherals to the peripheral of the window leaving the top edge free for the insertion of a visiting card; the area below the window of the filler being provided for taking notes including negotiation and summarized minutes of meeting related to the subject of the visiting card; and
multiple fillers being put together and bound to the binder.

2. The loose-leaf binder filler also functioning as an index card of claim 1, wherein, both see-through sheets are attached to the peripheral of the window either by sewing, HF fusion or adhesion.

3. The loose-leaf binder filler also functioning as an index card of claim 1, wherein, the area below the window on the filler is left blank, lined or checkered to facilitate taking notes.

4. The loose-leaf binder filler also functioning as an index card of claim 1, wherein, one longer side of the filler is punched multiple holes for the binder.
